(19) United States
(12) Patent Application Publication
(10) Pub. No.: US 2003/0217623 A1
(43) Pub. Date: Nov. 27, 2003

(54) Skateboard tool kit

(76) Inventor: David H. Brown, Vista, CA (US)

Correspondence Address: LITTMAN LAW OFFICES, LTD., P.O. BOX 15035 CRYSTAL CITY STATION, ARLINGTON, VA, 22215, US

(21) Appl. No.: 10/153,634

(22) Filed: May 24, 2002

(51) Int. Cl. B25F 1/00

(52) U.S. Cl. 81/437

(57) ABSTRACT

A skateboard tool kit which is easily carried. The kit has a tool-conforming container with a body containing 1 tools and a snap secured cover. It is vertically disposed and is generally elongate in cross section with a narrowed neck. An extension “L”-shaped wrench has at one end a socket drive for hex sockets and at the other end a hexagonal insert which fits hexagonal cavity within a wrench receiver tower extending upward into the container, supporting two hex sockets. The extension wrench hexagonal insert is inserted into the hexagonal cavity, making the container useful as a wrench handle. The outer side of the neck portion of the container has dimples formed therein to provide for a good grip by the user. An “L”-shaped combination wrench is of hexagonal stock and has a Phillips head screwdriver head and an Allen key head.

### BACKGROUND OF THE INVENTION

1. Field of the Invention

The present invention relates to specialty tools and accessories for sporting goods. More particularly, the present invention relates to a portable, multifunction skateboard tool kit for use in assembling, repairing and adjusting skateboards.

2. Description of the Related Art

In recent years skateboarding has become a popular leisure time activity. Skateboards frequently require maintenance, particularly when used in competitive events which require jumps and other athletic maneuvers. The skateboard may require adjustment or repair, which necessitates using socket wrenches of different sizes, a Phillips head screwdriver and/or an Allen key for securing the fasteners which retain the skate on the board, adjusting the axles, etc. The typical skateboarder does not want to be burdened by carrying around a tool box or a plurality of tools. There is a need for a combination, multifunction skateboard tool kit which is compact in size and lightweight for easy portability, and preferably pocket size so that it may be conveniently carried by the skateboarder. The related art describes various tool kit configurations combining multiple functions. The art of interest will be discussed in the order of their perceived relevance to the present invention.

U.S. Pat. No. 4,747,736, issued on Oct. 4, 1988, to William H. Brawner et al., describes a tool kit for use by a skateboarder, providing two sockets, two screw driver heads and an Allen wrench for use in repairing or adjusting skateboards. The Allen wrench is deployed by separating two portions of the body of the tool kit, thus exposing the Allen wrench.

U.S. Pat. No. 6,279,434 B1, issued on Aug. 28, 2001, to David H. Brown, the present inventor, describes an integral skateboard tool having three sockets, and having a bore for holding a combination Allen key wrench and Phillips head screwdriver.

U.S. Pat. No. 5,524,513, issued on Jun. 11, 1996 to R. J. Barahona, describes an in-line skate wheel and bearing tool having an Allen wrench storage cavity within the handle, a series of concentric staggered bearing tools, and an Allen wrench tip.

U.S. Pat. No. 5,524,513, issued on Jul. 14, 1998 to Seals et al., describes a combination smoking pipe and tool kit having a variety of sockets and a double ended screwdriver storable within the pipe stem having a standard blade head at one end and a Phillips head on the other end.

U.S. Pat. No. Des. 243,506, issued Mar. 1, 1997, to Hess, illustrates a skate board adjustment tool.

None of the above inventions and patents, taken either singularly or in combination, is seen to describe the instant invention as claimed. Thus, a skateboard tool kit solving the aforementioned problems is desired.

### SUMMARY OF THE INVENTION

The present invention is a tool kit particularly adapted to be useful in the assembly, repair, and adjustment of skate boards which is portable and may easily fit into a boarder's pocket. The kit has a generally tool-conforming container having a body which contains all tools and a snap secured closure cover. The container is generally elongated in shape along its vertical axis and has a half-round socket-containing portion and a half-round wrench-containing portion separated by a narrowed neck portion for holding an extension socket. The wrench-containing portion has a vertically extending longitudinal wall extending inward toward the neck portion and ending at a vertically extending lateral wall, thus providing separate quarter-round compartments. In the present invention, the longer shaft of each of two “L”-shaped wrenches fit into respective quarter-round compartments.

The socket-containing portion is sized to vertically contain a medium size (1\2 inch) socket and a large size (9\16 inch) socket, the medium socket fitting over a hexagonal shaped wrench receiving tower extending upward from the base wall of the socket-containing portion. The medium socket is supported hex end down and 1\4 inch drive end upward as separated by an inner wall. The large socket is then supported, hex side up and ¼ inch drive end downward by the smaller socket.

The container neck portion is separated from the socket-containing portion by two vertically extending, lateral partial walls and from the wrench-containing portion by the aforementioned lateral wall. An extension socket having a small (⅜ inch) hex socket, and a ¼ inch drive separated by an extension shaft is vertically inserted in the container neck portion with the hex socket opening upward. The container walls are tapered inward and vertical ribs are located so as to form a slight interference fit to help secure the tools in the container to avoid rattling and avoid spilling the tools accidentally while making their removal for use an easy task for the user.

An extension “L”-shaped wrench has at one end a socket drive end portion having a detent for insertion in the drive portion of either hex sockets. The other end of the extension “L”-wrench is shaped as an extended hexagonal insert end. The hexagonal insert end of the extension “L”-wrench is sized to fit within the a hexagonal cavity within the abovementioned wrench receiver tower and opening downward and outward from the base wall of the container such that the kit container may serve as a wrench handle. The outer side of the neck portion of the container has dimples formed therein to provide for a good grip by the user.

An “L”-shaped combination wrench is of hexagonal stock and has a Phillips head screwdriver head on one end. The other end of the combination wrench tapers to an Allen key wrench end. Either end of the combination wrench may be fit into the hexagonal wrench receiver in the base wall of the kit container so as to allow the container to be used as a handle when using the opposite end wrench head.

Accordingly, it is a principal object of the invention to tool kit which is useful for assembling, adjusting, and repairing skate boards.

It is another object of the invention to provide a tool kit as above which is portable and easily carried in a boarder's pocket.

It is a further object of the invention to provide a tool kit as above which provides multiple wrenches including a range of hex head drives, and a combination Phillips head and Allen key wrench.

It is yet another object of the invention to provide a tool kit as above wherein all tools are securely fit into a compact container.

Still another object of the invention is to provide a tool kit as above wherein the container serves as a wrench grip to provide leverage and comfort in using the contained wrenches.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a skateboard tool kit container according to the present invention.

FIG. 2 is a partially exploded view of the skateboard tool kit of FIG. 1 showing the tools in their spatial relationship when residing within the tool kit container.

FIG. 3 is an exploded bottom perspective view of the skateboard tool kit of FIG. 1 illustrating the relationship of the “L”-shaped adaptor wrench and a hex socket to the wrench receiver of the tool kit container of FIG. 1.

FIG. 4 is an exploded perspective view of the skateboard tool kit of FIG. 1 without the container cover.

FIG. 5. is a plan view of the kit container body of FIG. 1 absent the tools held therein.

FIG. 6 is a section view taken along line 6-6 of FIG. 5.

Similar reference characters denote corresponding features consistently throughout the attached drawings.

### DETAILED DESCRIPTION OF THE PREFERRED EMBODIMENT

The present invention is a tool kit, useful in the assembly, repair, and adjustment of skate boards which is portable and may easily fit into a boarder's pocket. The kit has a generally tool-conforming container having a body which contains all tools and a snap secured closure cover. The container is generally elongated in shape along its vertical axis and has a half-round socket-containing portion and a half-round wrench-containing portion separated by a narrowed neck portion for holding an extension socket.

An extension “L”-shaped wrench has at one end a socket drive end portion having a detent for insertion in the drive portion of any of the hex sockets. The other end of the extension “L”-wrench is shaped as an extended hexagonal insert end. The hexagonal insert end of the extension “L”-wrench is sized to fit within the a hexagonal recess within a wrench receiver tower supporting the loose hex sockets and opening downward and outward from the base wall of the container such that the kit container may serve as a wrench handle. The outer side of the neck portion of the container has dimples formed therein to provide for a good grip by the user. An “L”-shaped combination wrench is of hexagonal stock and has a Phillips head screwdriver head on one end. The other end of the combination wrench tapers to an Allen key wrench end.

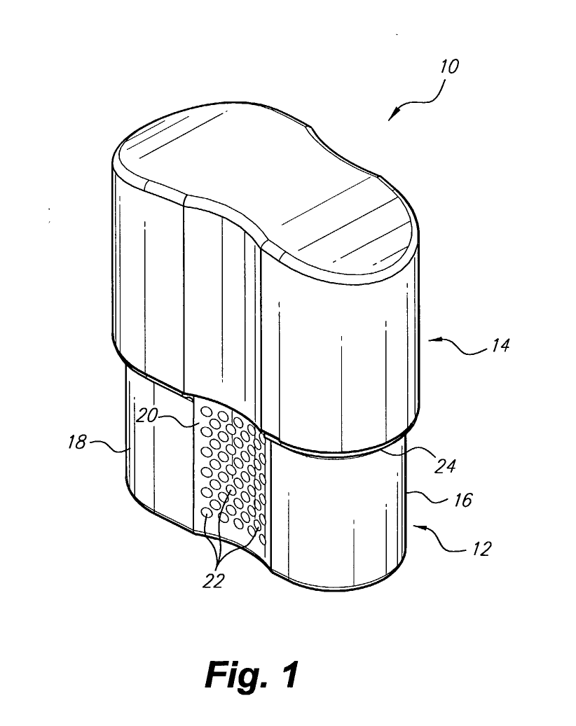

Referring to FIGS. 1, 2, and 4, there are shown a perspective view of the tool kit container in a closed position, a partially exploded perspective view, and an exploded view, absent the kit cover, of the tool kit of FIG. 1, respectively. Skateboard tool kit 10 includes kit container body 12 and kit container cover 14. Kit container body 12 is generally elongated in cross section and includes a wrench portion 16 and a socket portion 18 connected by narrowed neck portion 20. Wrench portion 16 and socket portion 18 are generally half-circular in shape with opposed openings connecting with neck portion 20. The socket portion 18 may be larger in radius than the wrench portion 16. Wrench portion 16 is defined by vertical wrench portion wall 17, socket portion 18 is defined by vertical socket portion wall 19, and neck portion 20 is defined by container neck portion opposing vertical walls 21.

Neck portion opposing vertical walls 21 are concave on each side of container 12 and have dimples 22 on their lower portion for improved hand grip. The walls 21 curve outward as required to meet the proximate ends of wrenchportion wall 17 and socket portion wall 19. Wrench portion wall 17, socket portion wall 19, and neck portion walls 20 together form container vertical wall 25 having upper rim 50. One neck portion wall 21 has a cover snap receiver groove 60 which receives corresponding cover snap ridge 61 located on the lower inside of cover 14. Container cover 14 fits over the abovementioned upper portions of vertical sidewall 25 of container body 12 and closes at semicircular lips 24 with snap ridge 61 engaging snap receiver groove 60 upon closure.

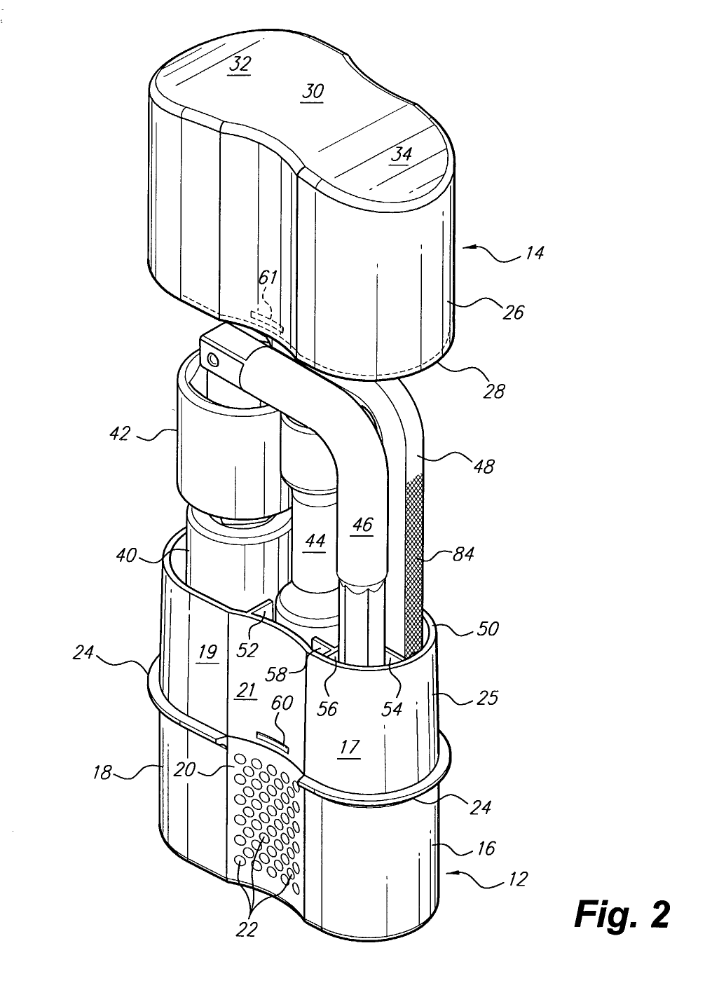

As seen in FIG. 2, cover 14 has a sidewall 26, a lower lip 28, and an upper end wall 30. Cover upper end wall 30 curves downward over upper wall socket portion 32 and downward over cover upper wall wrench portion 34, resulting in an arched top which fits against the various wrench parts as described below, keeping them in a snug position within the kit container body. The medium hex socket 40 and large hex socket 42 are secured within kit container socket portion 18.

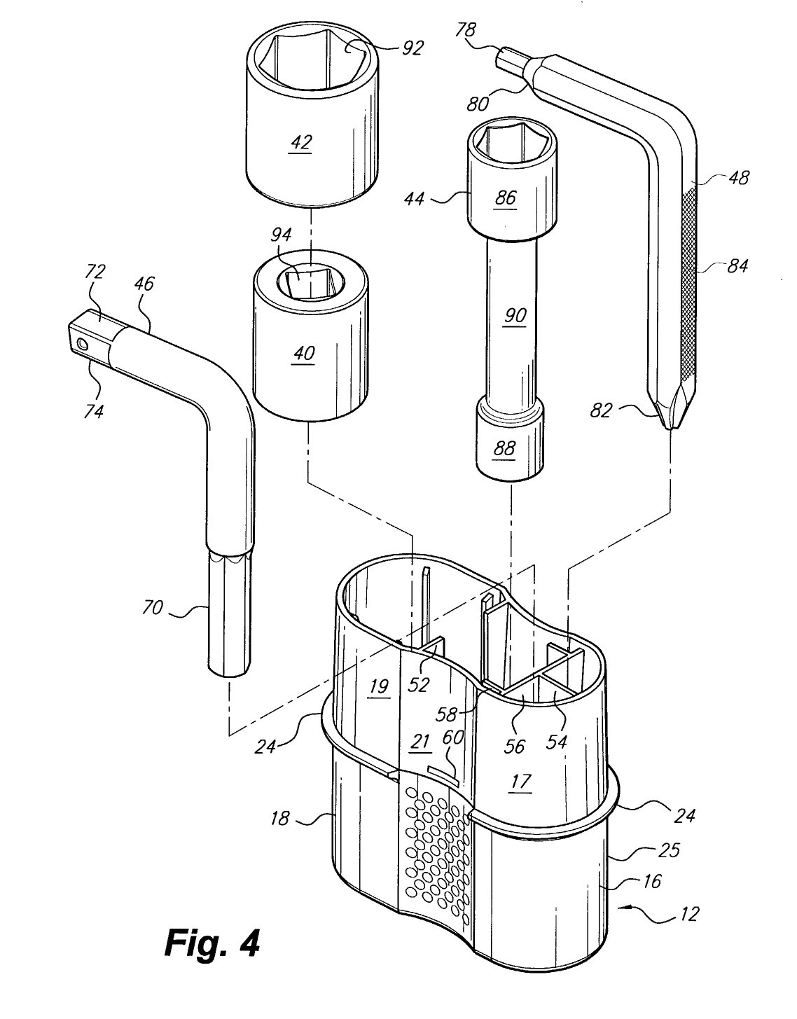

An “L”-shaped adapter wrench 46 (see FIG. 4) has a long portion extending downward within container wrench portion 16 having a hexagonal end portion 70, the adapter wrench 46 having a short portion having a square cross section drive end 72 having a detent 74 for positively engaging the abovementioned socket drives.

An “L”-shaped combination wrench 48, has a long portion (see FIG. 4) extending downward into the wrench receiver portion of the container body and ending in a Phillips screwdriver head 82, and having a short portion ending in an Allen key wrench end 78. The combination wrench 48 is of hexagonal cross section and the long portion has a flat opposite the extension of the short portion, the long portion flat having a bastard cut file 84 cut therein toward the Phillips head end 82 and extending substantially the length of the flat.

The wrench portion 16 has a vertically extending, longitudinal dividing wall 52 separating the wrench portion into two compartments, for separately receiving the long portion of adapter wrench 46 and the long portion of combination wrench 48 and extending from the apex of wrench portion vertical wall 17 and a vertically extending radial dividing wall 56. Dividing wall 56 separates wrench portion 16 and neck portion 20 of container body 12 and, along with dividing wall 52, defines two quarter-circular compartments for separately receiving the respective long portions of adapter wrench 46 and combination wrench 48.

Socket portion 18 has two vertically extending, radial dividing walls 52 separating socket portion 16 and neck portion 20 of said container body. The dividing walls 52 extend inward toward each other from points on the inner side of neck walls 21 near the respective ends of socket portion 18. As is seen in FIGS. 2 and 4, the socket portion 16 extends into the space between the proximate ends of neck walls 21, ending at dividing walls 52.

Neck portion 20 removably contains extension hex socket 44 having a small hex socket 86 and a drive socket 88 coaxial therewith and connected by an extension shaft 90. The extension hex socket 44 is stored vertically with the hex socket 86 opening upward. Two spaced vertical support walls 58 extend longitudinally inward from radial dividing wall 56 into neck portion 20 to maintain the extension hex socket in a snug position within neck portion 20 when stored therein.

As is seen in FIGS. 2 and 4, medium hex socket 40 is stored with the driven end containing drive receiver 94 in the upward position, and large hex socket 42 is stored with hex receiving socket 92 opening upward.

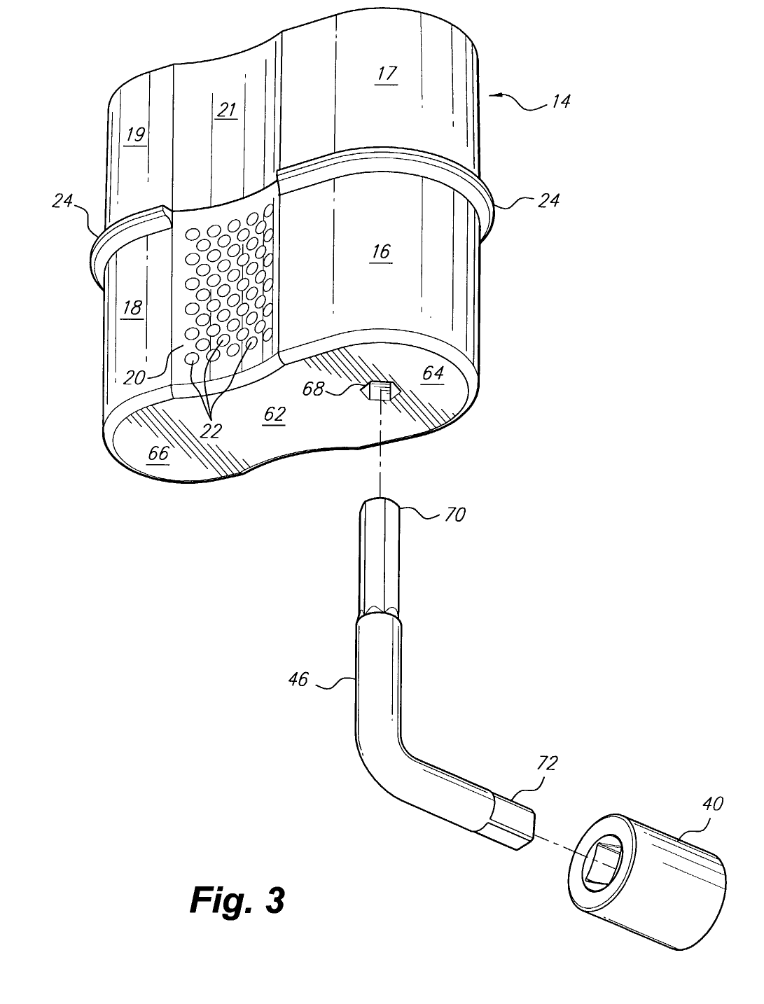

Referring to FIG. 3, kit container body 12 (see FIG. 1) has a base wall 62 closing container body 12 and having a base wall socket portion 64 and a base wall wrench portion 66. Base wall socket portion 64 has a centrally located wrench receiver 68 so sized and configured as to fittingly receive the hexagonal end portion 70 of adapter wrench 46. Socket drive portion 72 fits any of the drive receivers of any of the hex sockets provided in the kit 10, hex socket 40 being shown as an example. When assembled, container body 12 acts as a handle for wrench 46, assisting the user in turning a hex socket during skateboard adjustment and repair. Wrench receiver 68 also accepts either end of combination wrench 48, allowing the use of the tool on the opposite end to be turned using container body 12 as a handle.

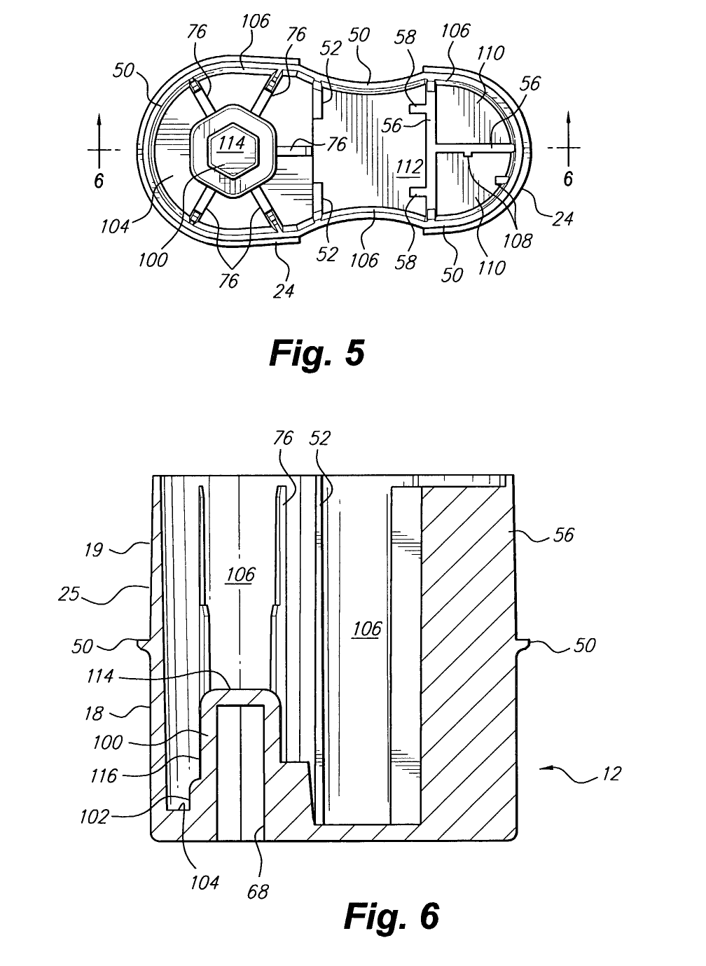

Referring to FIGS. 5 and 6, there is shown a plan view of the container body 12 with cover 14 removed, and a sectional view of container body 12, respectively, wherein container vertical wall 25 has an upper rim 50 and slopes inward along its inner sidewall 106 until it reaches socket portion floor 104, wrench portion floor 110, and neck portion floor 112. Also, socket radial dividing walls 52 slant inward toward socket portion 18 as they reach toward socket portion floor 104. These slanting walls provide a slight interference fit for the wrenches and hex sockets contained therein (see FIGS. 2 and 4), holding them in place when not in use. One of the wrench compartments formed by longitudinal dividing wall 54 and radial dividing wall 56 has adapter wrench fitting ribs 108 extending inward from dividing wall 54 and inner side wall 106 for supporting the generally round adapter wrench in a vertical position and forming an interference fit. The other wrench compartment supports generally hexagonal combination wrench through an interference fit with inner side wall 106.

Base wall wrench receiver 68 is formed by wrench receiving hexagonal tower 100 extending upward from socket portion floor 104 and stiffener 102 and has a top wall 114 and side hexagonal side wall 116 to provide an overall sealed container body. The hexagonal cavity of medium socket 40 fits over top wall 114 and hexagonal side wall 116 Socket portion 18 has a thicker base wall 64 than the remaining base wall 62 and therefore a higher floor 104 than floor 112, acting as an additional stiffener, along with stiffener 102 to provide support when container body 12 is used as a wrench handle as described above. Stepped ribs 76 extend radially from socket portion vertical wall 19 inward toward wrench receiving tower 100 for providing lateral support to sockets 40 and 42 (see FIGS. 1 and 2) when they are in place within kit 10. Stepped ribs 76 extend inward along floor 104 to stiffener 102 and, along with tower top 14, provide vertical support to socket 40.

As seen in FIG. 2, the long portions of adapter wrench 46 and combination wrench 48 are inserted into their receiving compartments and their short ends placed over the extension socket 44 and part of the large socket 42. Kit cover 14 has an upper wall 30 having upper wall socket portion 32 and upper wall wrench portion 34. Kit cover 30 may be arched such that upper wall socket portion 32 and upper wall wrench portion 34 conform closely with the wrenches stored in container body 12 when cover lower rim 28 is closed against lips 24 and snap ridge 61 engages snap receiver 60.

In operation, kit container cover 14 is removed from kit container body 14 and an appropriate wrench is removed. If a hex socket is required, adapter wrench 46 is removed and the appropriate socket removed and installed on the wrench drive portion, and the cover 14 replaced on the container body 12. The appropriate hex cross section portion of the wrench is inserted into wrench receiver 68 and the container body 12 is used as a handle to turn the selected wrench or tool head. When the task is finished, the cover is removed and the wrench and any socket is placed in the container body and stored as described above, and the cover placed on the container body and the kit closed for storage or transport, such as in the user's pocket.

The socket-containing portion is preferably sized to vertically contain a medium size (1\2 inch) socket and a large size (9\16 inch) socket, the medium socket fitting over the hexagonal shaped wrench receiving tower extending upward from the base wall of the socket-containing portion. The extension socket preferably has a small (⅜ inch) hex socket with an extension shaft of about 1 inch and is vertically inserted in the container neck portion with the hex socket opening upward. All socket drives are ¼ inch drives. The extension socket is about 2 inches in overall length.

The combination wrench has a long portion of about 2.3 inches and a short portion of about 1.4 inches in length. The adapter wrench has a long portion of about 2.3 inches and a short portion of about 1.4 inches in length. The overall height of the kit is about 2 inches and the overall width is about 2 inches. The depth of the kit is about 1 inch at the socket portion and about 0.84 inches at the wrench portion of the kit. The container and top are preferably made of tough, high impact plastic and the wrenches and sockets are steel or other appropriate material.

It is to be understood that the present invention is not limited to the embodiment described above, but encompasses any and all embodiments within the scope of the following claims.

I claim:

1. A skateboard tool kit comprising:
a vertically oriented, self standing, generally elongated, tool-conforming container having a container body having a base wall, a vertical side wall, and an upper lip and having a cover extending downward over said lip having and a sidewall conforming with said container body vertical side wall;
said elongated container body having a socket portion forming one end and a wrench portion forming an opposite end thereof;
at least one generally cylindrical hex socket having a driven end portion and stored in said socket portion of said container lower body; and
a wrench having a drive end so sized and configured as to fit within said driven end portion of said hex socket, said wrench stored being stored within said wrench portion of said container lower body;
whereby said at least one hex socket and said wrench may be removed from said container by removing said cover, retrieving said socket and said wrench, and assembling them for use on a skateboard.

2. The skateboard tool kit of claim 1, wherein said wrench is an “L”-shaped adapter wrench having a long portion located within said container wrench portion and having a short portion bearing said drive end, said drive end having a detent for positively engaging said socket drive.

3. The skateboard tool kit of claim 2, said container body socket portion having a horizontal floor and a vertically oriented tower extending upward from said floor, said tower supporting said at least one hex socket, said tower defining a wrench drive receiver channel extending axially downward therethrough and opening outward from said container base wall, said long portion of said adapter wrench being so sized and configured as to be inserted within said drive receiver channel for the driving thereof, whereby said long portion of said adapter wrench is inserted within said drive receiver channel of said tower allowing use of said container body to be useful as a handle for turning said short portion of said wrench and thereby driving said socket.

4. The skateboard tool kit of claim 3, wherein said long portion of said adapter wrench and said drive receiver channel are hexagonal in cross section.

5. The skateboard tool kit of claim 4, said container wrench portion and said container socket portion being connected by a neck portion having opposing concave walls.

6. The skateboard tool kit of claim 5, further comprising an extension hex socket having a small hex socket and a drive socket coaxial therewith and connected by an extension shaft, said extension hex socket being stored vertically within said neck portion.

7. The skateboard tool kit of claim 6, wherein said wrench portion and said socket portion of said container body form generally half-round opposing ends of said side wall and connect with said concave walls of said neck portion to form the complete vertical sidewall of said container body.

8. The skateboard tool kit of claim 7, wherein said at one hex socket comprise a medium socket and a large socket, said medium socket having a hex head end and a drive end separated by a radial wall, said medium hex socket being supported on said wrench receiver tower by said radial wall within its hex head cavity, said large socket being supported on its drive receiver end by said small hex socket drive end.

9. The skateboard tool kit of claim 7, further comprising an “L”-shaped combination wrench, having a long portion extending downward into said wrench receiver portion of said container body.

10. The skateboard tool kit of claim 9, said combination wrench having a Phillips screwdriver head on the end of said long portion, and an Allen key wrench end on the end of a short portion.

11. The skateboard tool kit of claim 10, wherein said combination wrench long portion and short portion are hexagonal in cross section.

12. The skateboard tool kit of claim 11, wherein said long portion has a flat opposite said short portion comprising a file cut therein and extending substantially the length thereof.

13. The skateboard tool kit of claim 9, wherein said wrench portion further comprises a longitudinal dividing wall separating said adapter wrench and said combination wrench, and a radial dividing wall separating said wrench portion and said neck portion of said container body.

14. The skateboard tool kit of claim 5, wherein said socket portion further comprises radial dividing walls separating said socket portion and said neck portion of said container body.

15. The skateboard tool kit of claim 14, wherein said vertical wall of said container body slopes inward from said lip to said base wall, whereby said sockets and wrenches are held within their respective container portions by forced fit.

16. The skateboard tool kit of claim 15, further comprising vertically extending positioning ribs extending inward from said container vertical wall and said longitudinal dividing wall into the cavity formed thereby and holding said adapter wrench in place relative to said container body.

17. The skate board kit of claim 15, further comprising spaced apart, vertically extending positioning ribs extending longitudinally from said radial dividing wall into said neck portion and holding said extension hex socket in place relative to said container body.

18. The skate board kit of claim 15, further comprising vertically extending positioning ribs spaced radially inward from said vertical wall into said socket portion for holding said medium socket and said large socket in place relative to said container body, said positioning ribs extending radially inward along said floor of said socket portion to said wrench receiving tower.

19. The skate board kit of claim 18, wherein said adapter wrench and said combination wrench are arranged such that their respective short portions are positioned longitudinally and extend over said extension socket and partially over said large hex socket so as to allow said container cover to be closed over said vertical wall upper lip and extended downward over the upper portion of said vertical wall.

20. The skate board kit of claim 19, wherein said kit container cover is arched so as to conform with said wrenches as positioned within said container body.
